(19) United States
(12) Patent Application Publication
(10) Pub. No.: US 2003/0057699 A1
(43) Pub. Date: Mar. 27, 2003

(54) Coupling assembly with rotation lock

(76) Inventors: Matthew M. Persohn, Toledo, OH (US); James Lashaway, Bowling Green, OH (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 09/977,543

(22) Filed: Oct. 15, 2001

Related U.S. Application Data
(63) Continuation-in-part of application No. 09/965,464, filed on Sep. 27, 2001.

(51) Int. Cl. F16L 35/00; F16L 55/00

(52) U.S. Cl. 285/39; 285/321; 285/330; 285/913

(57) ABSTRACT

A coupling assembly is provided comprising a first member and a second member. The first member includes an exterior surface having one or more engagement features. The second member includes a portion for receiving a portion of the first member having one or more locking features configured to mate with the engagement features of the first member to prevent rotation of the first member relative to the second member while connected thereto. When the first member is securely retained within the second member, the first and second members comprise a coupling assembly suitable for both low-pressure and high-pressure coupling applications. Further, depending upon the circumstances and intended environment, the second member may be configured with features for quick-connect and/or disconnect from a corresponding first member.

### RELATED APPLICANTIONS

The present application is a continuation-in-part of U.S. patent application Ser. No. 09/965,464, filed Sep. 27, 2001, the disclosure of which is incorporated by reference herein in its entirety.

### BACKGROUND OF THE INVENTION

1. Field of the Invention

The present invention relates generally to a coupling assembly for connecting two members together and more particularly to a coupling assembly including a means of preventing rotation of one coupling member relative to the other coupling member.

2. Description of the Related Art

Coupling assemblies for the transmission of gases or fluids that may be secured in place by a simple axial movement of a male coupling member into a female coupling member are known in the art. U.S. Pat. Nos. 5,226,682; 5,553,895; and 5,570,910, which are owned by the assignee of the present application, disclose various embodiments of a coupling assembly configuration that may be secured together by a simple axial movement of a male member into a female member. A limitation of this configuration is that the male coupling member is permitted to rotate relative to the female coupling member during connection thereto. However, certain coupling assembly installations require that a male coupling member be locked against rotation relative to the female member, rendering the coupling assembly described above unsuitable for this type of installation.

### SUMMARY OF THE INVENTION

The present invention provides an effective coupling assembly that prevents rotation of the male member relative to the female member during connection thereto. In accordance with an embodiment of the present invention, a coupling assembly is provided that comprises a first coupling member and a second coupling member. The first member includes an exterior surface having one or more engagement features. The second member includes a portion for receiving a portion of the first member. The receiving portion includes at least one interior surface having one or more locking features configured to mate with the engagement feature of the first member to substantially prevent rotation of the first member relative to the second member during connection thereto. The engagement feature is defined by one or more protrusions in the exterior surface of the first member. The protrusions preferably extend radially with respect to a base diameter. The locking feature is defined by one or more interruptions in the interior surface of the receiving portion. The interruptions extend radially in the same direction as the protrusions of the first member with respect to the base diameter. The engagement and locking features are shaped and circumferentially located to engage and create radial interference.

In a preferred embodiment of the present invention, the engagement feature of the first member comprises a plurality of teeth and the locking feature of the second member comprises a plurality of grooves. When the first member is inserted into the second member, the teeth of the first member intermesh with the grooves of the second member to prevent rotation of the first member relative to the second member.

In another embodiment of the present invention, the engagement feature of the first member comprises a plurality of spaced apart tabs. The locking features of the second coupling member comprise a plurality of slots that receive the tabs of the first member upon insertion of the first member into the second member to prevent rotation of the first member relative to the second member.

When the first member is securely retained within the second member, the first and second members comprise a coupling assembly that may be suitable for both low-pressure and high-pressure coupling applications. Further, depending upon the circumstances and intended environment, the second member may be configured with features for quick-connect and/or disconnect from the first member.

Among other advantages, the coupling assembly of the present invention prevents rotation of the first member relative to the second member while connected thereto. Another advantage is that the locking feature of the second member may be used in conjunction with a tool to connect the second member to an apparatus, such as a pump or manifold. Still another advantage is that the invention provides improved tactile feel that the first member has been satisfactorily connected to the second member during assembly. The present invention also lends itself to providing, when appropriate and desired, a quick-connect and/or releasable coupling assembly.

### BRIEF DESCRIPTION OF THE DRAWINGS

FIG. 1 is a partial cross-sectional view of a preferred embodiment of the present invention illustrating the coupling members in the connected position.

FIG. 1A is an enlarged fragmentary view of retaining formation, locking member and release member of the fully coupled assembly of FIG. 1.

FIG. 1B is an enlarged fragmentary view showing another embodiment of the receiving portion of the second member.

FIG. 1C is an enlarged fragmentary view showing yet another embodiment of the receiving portion of the second member.

FIG. 2 is a cross-sectional view along line 2-2 in FIG. 1 illustrating the coupling members in the connected position.

FIG. 2A is an enlarged cross-sectional view of FIG. 2 showing the engagement and locking features.

FIG. 3 is a cross-sectional view illustrating the engagement and locking features according to a second embodiment of the present invention.

FIG. 3A is a cross-sectional view illustrating the engagement and locking features according to a variation of the second embodiment.

FIG. 4 is a cross-sectional view illustrating a variation of the second embodiment of the present invention.

FIG. 5 is a partial cross-sectional view of a coupling assembly according to a third embodiment of the present invention.

FIG. 6 is a cross-sectional view along line 6-6 in FIG. 5 illustrating the coupling members in the connected position.

FIG. 7 is a cross-sectional view illustrating the coupling members of FIG. 5 with engagement and locking features according to the second embodiment.

FIG. 8 is a cross-sectional view illustrating the coupling members of FIG. 5 with engagement and locking features according the variation of the second embodiment.

FIG. 9 is a partial cross-sectional view of a coupling assembly according to a fourth embodiment of the present invention.

FIG. 10 is a partial cross-sectional view of a coupling assembly according to a fifth embodiment of the present invention.

FIG. 11 is a partial cross-sectional view of a coupling assembly according to a sixth embodiment of the present invention.

FIG. 12 is an exploded partial cross-sectional view of the coupling assembly of FIG. 11 prior to assembly.

FIG. 13 is a partial cross-sectional view of a coupling assembly according to a seventh embodiment of the present invention.

### DESCRIPTION OF THE PREFERRED EMBODIMENT

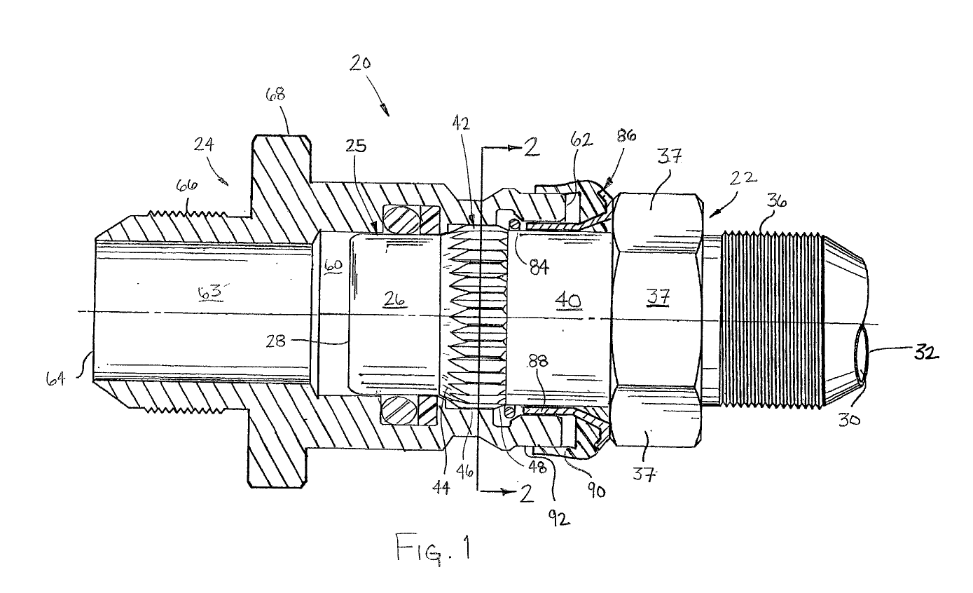

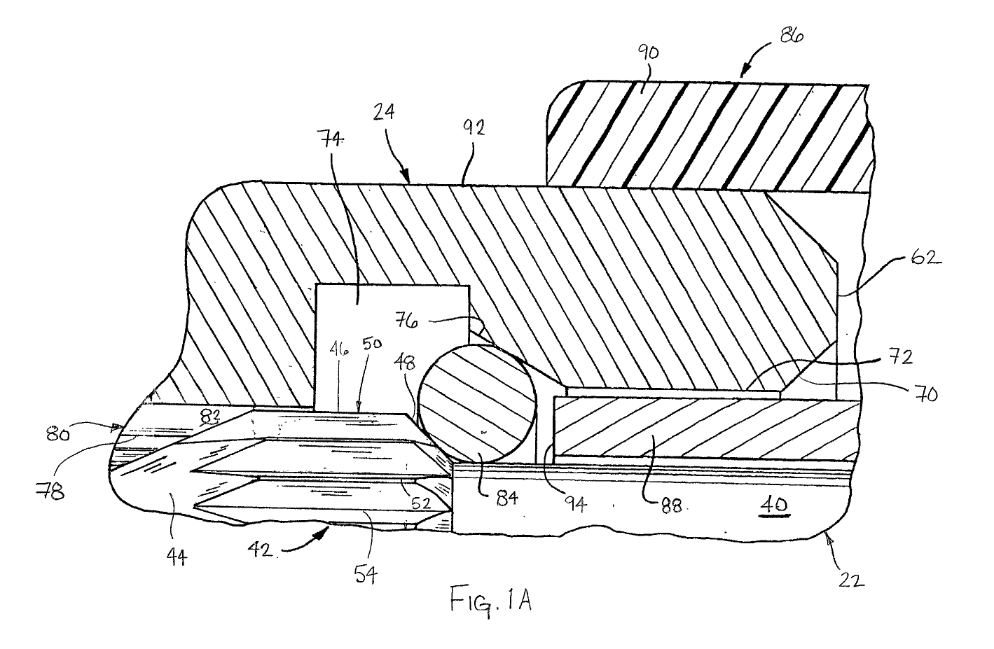

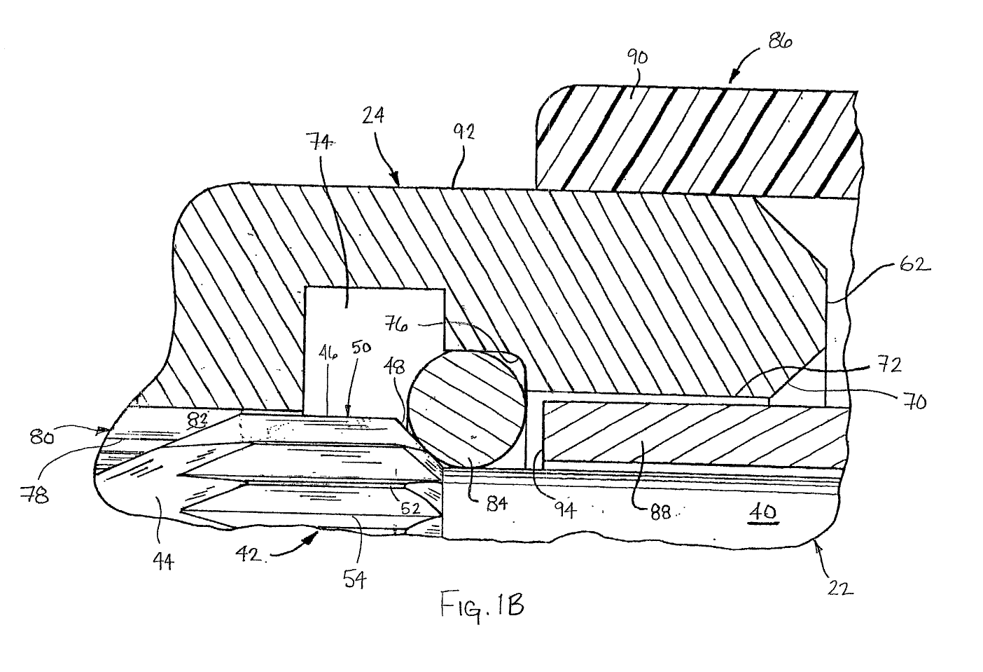

Referring now to the drawings, preferred embodiments of the present invention are described in detail. Referring to FIG. 1, a coupling assembly 20 is provided that includes a first member 22 and a second member 24 shown in the connected configuration. Members 22 and 24 preferably have a generally tubular shape. First member 22, which functions as the “male” member of coupling assembly 20, includes a protrusion 25 having a first exterior surface 26 adjacent an engagement end 28 intended for insertion into second member 24. When the first member 22 is securely retained within the second member 24, the first and second members 22, 24 comprise a coupling assembly suitable for both low-pressure and high-pressure coupling applications.

While coupling assembly 20 will be described herein as having features that provide for a quick-connect and/or releasable coupling assembly, it is not intended to be limited thereto. Accordingly, the rotation lock features of the present invention will function satisfactorily in coupling assemblies having non-quick connect features as well as coupling assemblies that are not releasable.

As illustrated in FIG. 1, first member 22 includes a duct 30 extending therethrough from engagement end 28 to an attachment end 32. If desired, attachment end 32 may be provided with external threads 36 or other suitable connection means for attachment to a threaded coupling (not illustrated) or other member, such as a flexible conduit or hose. First member 22 may also include a plurality of flats 37 defining a polygonal cross-section for engagement by a wrench.

First member 22 further includes a second exterior surface 40, which is separated from first exterior surface 26 by a retaining formation 42. The retaining formation 42 preferably includes a ramp 44 tapering outwardly from first exterior surface 26 in a direction away from engagement end 28. Ramp 44 preferably extends to an apex (46) represented in the preferred embodiment as a generally flat surface (as best illustrated in FIG. 1A) of retaining formation 42 that is substantially parallel to first and second exterior surfaces 26 and 40, respectively, and extends away from ramp 44 a distance of at least approximately 0.050 in (1.27 mm) until it meets a shoulder 48.

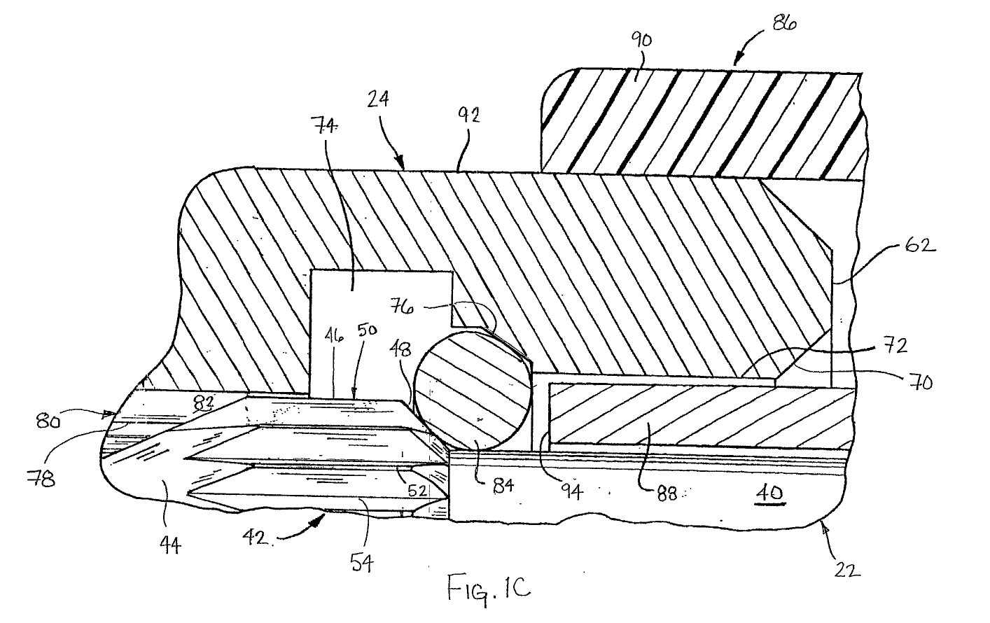

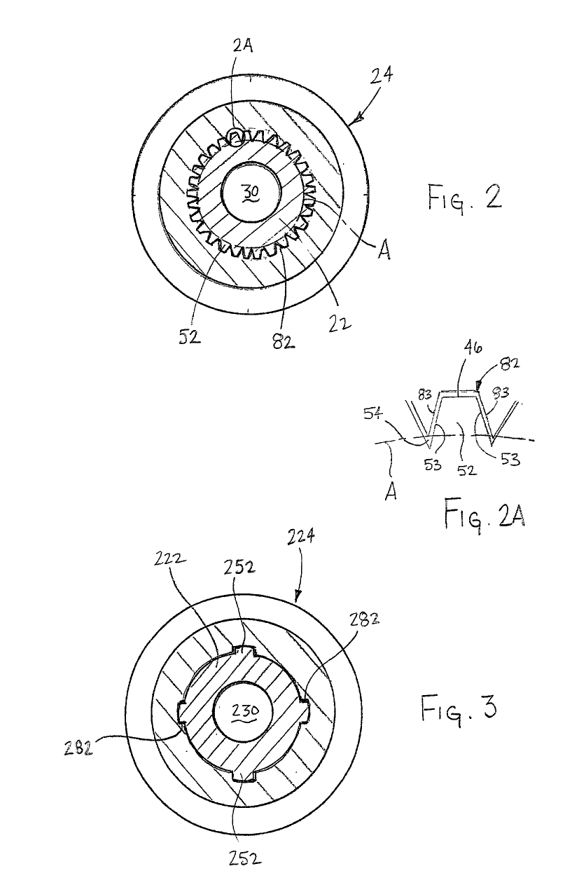

Retaining formation 42 preferably includes one or more engagement features 50, each defined by one or more protrusions extending radially outwardly from a base diameter A, shown in FIG. 2 as a base reference point, and defining apex 46. In a preferred embodiment, engagement features 50 comprise a plurality of teeth 52 that are defined by a plurality of similarly spaced-apart grooves 54 that extend radially inwardly from apex 46. In this configuration, apex 46 defines the outer surface of teeth 52 such that apex 46 exhibits a splined appearance, much like that of a typical gear.

Referring again to FIG. 1, second member 24 generally functions as the “female” member of coupling assembly 20 and is designed to receive a portion of the first member 22. Second member 24 includes a receiving portion 60 that extends from a receiving end 62. The receiving portion 60 is in communication with a duct 63 that extends through the remainder of second member 24 to a trailing end 64. Trailing end 64 is preferably provided with a means of attaching the second member 24 to an apparatus (not illustrated), such as, for example, a pump or manifold. By way of example, second member 24 may include an external thread 66, as illustrated in FIG. 1, for attachment to a threaded port of an apparatus, but is not intended to be so limited. Accordingly, other means of attaching second member 24 to an apparatus may be employed, as will be described in further detail below.

Referring to FIGS. 1-1C, preferably, a first chamfer 70 extends inwardly from receiving end 62 to a first interior surface 72. First interior surface 72 includes a first inwardly facing substantially annular groove 74 extending radially outwardly therefrom. A second chamfer 76 extends inwardly from first annular groove 74 toward receiving end 62 until it meets first interior surface 72. As illustrated in FIGS. 1A-1C, chamfer 76 is used in a generic sense and may comprise an angled surface, a well defined retaining groove, or a power engagement groove comprising both an angled surface and a retaining groove in a blended embodiment. Second member 24 preferably includes a second interior surface 78 that is joined to first annular groove 74. The inside diameter of second interior surface 78 is larger than the diameter of first exterior surface 26 on first member 22 to allow first member 22 to be received within second member 24.

The second interior surface 78 has formed therein one or more locking features 80 that are configured to mate with the engagement feature 50 of first member 22. As illustrated in FIGS. 2 and 2A, each locking member 80 is defined by one or more interruptions in second exterior surface 78, the interruptions extending radially outwardly from base diameter A. In this configuration, the engagement and locking features 50, 80 are received in the corresponding protrusion and interruptions of the opposing members 22, 24 to create a radial interference.

In a preferred embodiment, locking features 80 comprises a plurality of grooves 82 that extend outwardly from second interior surface 78 such that second interior surface 78 exhibits a splined appearance. The grooves are defined by sidewalls 83 that are in close tolerance with the dimension of side-walls 53 of teeth 52 such that there is limited clearance between the teeth 52 and grooves 82. As first member 22 is inserted into second member 24, teeth 52 of first member 22 are received into grooves 82 in second member 24 to substantially prevent rotation of first member 22 relative to second member 24.

It will be appreciated by those skilled in the art that the present invention is not limited to the engagement features 50 and the locking features 80 described in the preferred embodiment. What is essential to the present invention is that the engagement feature 50 is defined by one or more protrusions extending radially outwardly with respect to a base diameter in a surface of first member 22 and the locking feature 80 is defined by one or more interruptions in an opposing surface of second member 24, extending radially outwardly with respect to the base diameter. The protrusions and interruptions are adapted to matingly engage with limited clearance with respect to the mating surfaces. Thus, in the illustrated embodiment, teeth 52 may be disposed in second member 24 and grooves 82 may be disposed in first member 22 such that teeth 52 are received into grooves 82 when first member 22 is inserted into second member 24.

Referring again to FIG. 1A, received in first annular groove 74 is an annular locking member 84 preferably formed of a metal, and more preferably stainless steel. In a preferred embodiment the metal of locking member 84 is spring tempered so that locking member 84 has flexibility to expand and return to its original shape. Preferably, locking member 84 is not continuous, but includes a space between two ends (not illustrated), thereby allowing locking member 84 to expand and contract without substantially altering its annular shape.

While first member 22 is disconnected from second member 24, locking member 84 has an external diameter less than the inside diameter of first annular groove 74 but larger than the diameter of first interior surface 72. Additionally, locking member 84 has an internal diameter substantially equal to or, preferably slightly smaller than that of second exterior surface 40 of first member 22 allowing locking member 84 to tightly engage first member 22 when connected to second member 24.

As first member 22 is inserted into second member 24, engagement end 28 and first exterior surface 26 pass through the inside diameter of locking member 84 until ramp 44 reaches locking member 84. Upon further insertion, locking member 84 is forced to travel up ramp 44 thereby expanding locking member 84 until it reaches apex 46. As apex 46 moves past locking member 84, the resilience of the metal contracts locking member 84 as it travels down shoulder 48, until it contacts second exterior surface 40. Due to the preferably long length of apex 46, a user connecting coupling assembly 20 is better able to sense the transition from the unlock to the locked configuration as locking member 84 expands up ramp 44, travels across apex 46 and then contracts down shoulder 48. When compared to the prior art, coupling assembly 20 provides a user improved tactile feel during assembly that the first member 22 has been satisfactorily connected to the second member 24.

Upon complete insertion of first member 22 into second member 24, locking member 84 is positioned substantially between shoulder 48, chamfer 76 and second exterior surface 40. Movement of first member 22 in a direction away from second member 24 generally forces locking member 84 to engage both shoulder 48 and chamfer 76 thereby preventing the removal of first member 22 from second member 24.

A release member 86 suitable for releasing first member 22 from second member 24 may be moveably mounted on the second exterior surface 40 of first member 22. Release member 86 generally comprises a rigid release portion 88 and a flexible sealing portion 90. Flexible sealing portion 90 comprises a polymeric material, such as, for example, a thermoset elastomer. Upon insertion of first member 22 into second member 24, flexible sealing portion 90 sealingly engages an external surface 92 of second member 24 to substantially inhibit the entry of contamination, such as dirt and other debris, into the area surrounding locking member 84. When release member 86 is forced to travel axially toward locking member 84, a distal end 94 of rigid release portion 88 engages and forces locking member 84 to expand over retaining portion 42 allowing first member 22 to be removed from second member 24.

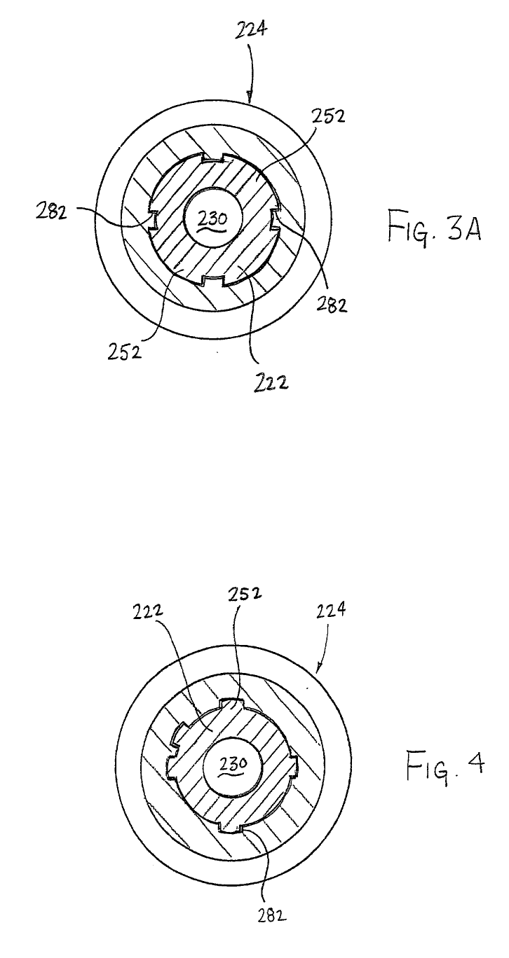

Referring to FIG. 3, a second embodiment of the present invention is shown in detail. In this embodiment, a first or “male” coupling member 222 is provided that is substantially similar to first member 22 described in the preferred embodiment with at least one exception, namely, engagement features 50 comprise a plurality of spaced apart tabs 252. A second or “female” coupling member 224 is also provided that is substantially similar to second member 24 described in the preferred embodiment with at least one exception, namely, locking features 80 comprise a plurality of slots 282 that are configured to receive tabs 252 upon insertion of first member 222 into second member 224. Tabs 252 may be substantially rectangular in cross-section, as illustrated in FIG. 3, or may exhibit other geometric cross-sectional profiles, such as, for example, a triangular cross-sectional profile. Additionally, each tab 252 may be equidistantly spaced apart from each adjacent tab 252, as illustrated in FIG. 3, or non-equidistantly spaced apart, as illustrated in FIG. 4.

As illustrated in FIG. 3, tabs 252 and slots 282 are spaced apart such that first member 222 may be inserted into second member 224 in one of four possible orientations, each approximately 90° apart. On the other hand, tabs 252 and slots 282 may be spaced apart, as illustrated in FIG. 4, such that first member 222 may be inserted into second member 224 in only one possible orientation. Alternatively, as shown in FIG. 3A, tabs 252 may be substantially larger and slots 282 may be substantially smaller creating what is essentially the inverse of the engagement features 250 and locking features 280 shown in FIG. 3.

As will be appreciated, the use of a small number of engagement features 50 will require that engagement features 50 be substantially, but not necessarily equidistantly, spaced apart in order to properly expand locking member 84 over retaining portion 42. As will also be appreciated, the cross-sectional profile, position and number of engagement features 50 described in the preferred and second embodiments are by way of example only and that other engagement features 50 having similar function are within the scope of this invention.

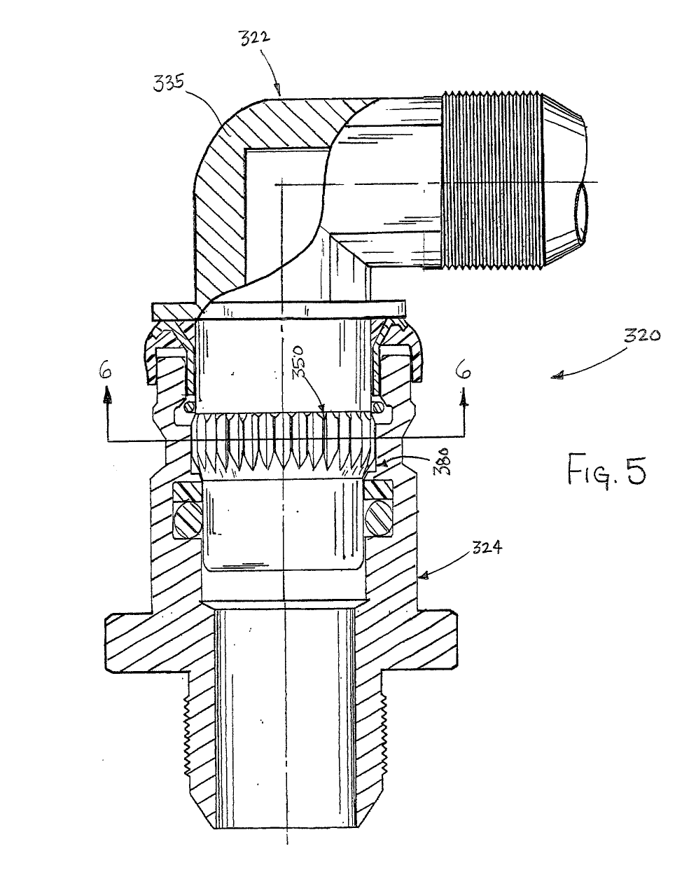

A third embodiment of the present invention is illustrated in FIG. 5. In this embodiment a coupling assembly 320 is provided having a first or “male” member 322 that is substantially similar to first member 22 described in the preferred embodiment with at least one exception, namely, first member 322 includes an elbow 335. Elbow 335 may exhibit an angle of approximately 90°, as illustrated in FIG. 5, or may exhibit other angles such as, for example, 45°. While coupling assembly 320 is illustrated as having engagement and locking features 350 and 380 similar to the engagement and locking features described in the preferred embodiment, it is not intended to be so limited. Accordingly, coupling assembly 320 may include other engagement and locking features, such as those described in the second embodiment.

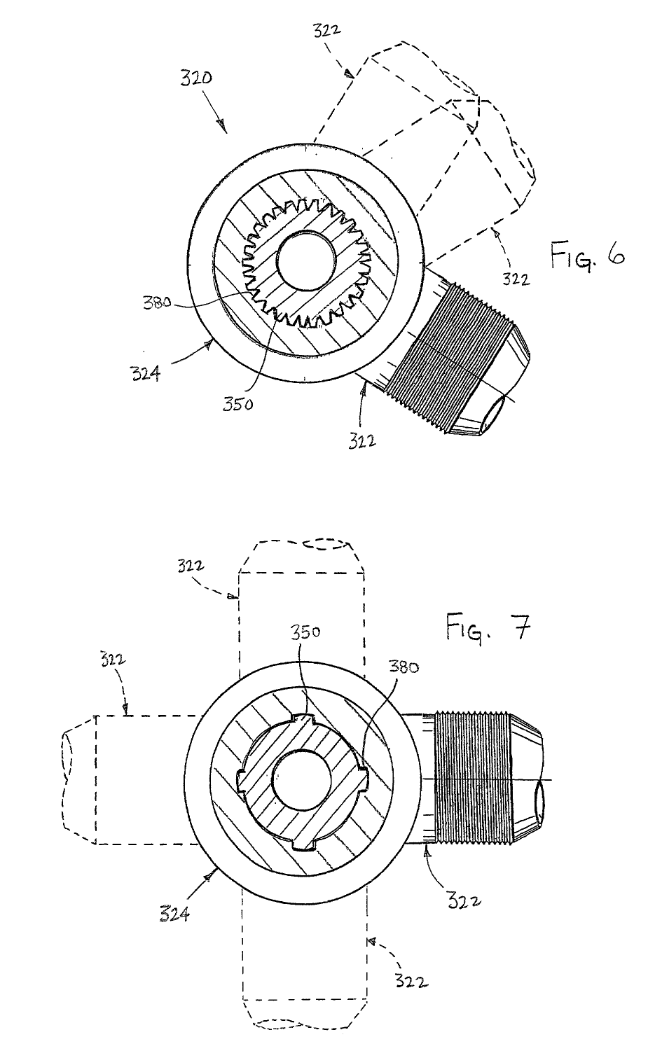

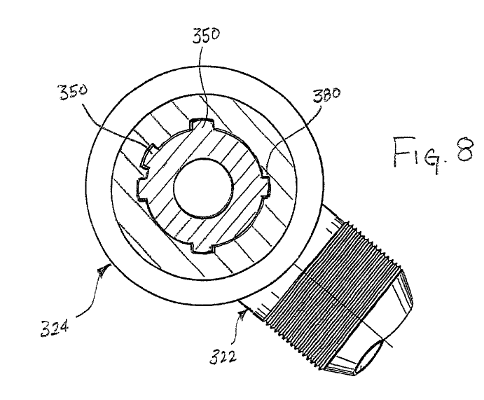

FIG. 6 is a cross sectional view of coupling assembly 320 showing the first member 322 installed in the second member 324. As illustrated in FIG. 6, first member 322 is shown inserted into second member 324 in one of several possible orientations. Referring to FIG. 7, a cross sectional view of coupling assembly 320 is shown having engagement and locking features 350, 380 similar to those described above in the second embodiment. As illustrated in FIG. 7, first member 322 is shown inserted into second member 324 in one of four possible orientations, each approximately 90° apart. Engagement and locking features 350, 380 may also be spaced apart, as illustrated in FIG. 8, such that first member 322 may be inserted into second member 324 in only one possible orientation. The configuration of engagement and locking features 350, 380 illustrated in FIG. 8 is particularly advantageous when elbow 335 must be pointing in a particular direction after the first and second members 322, 324 are coupled.

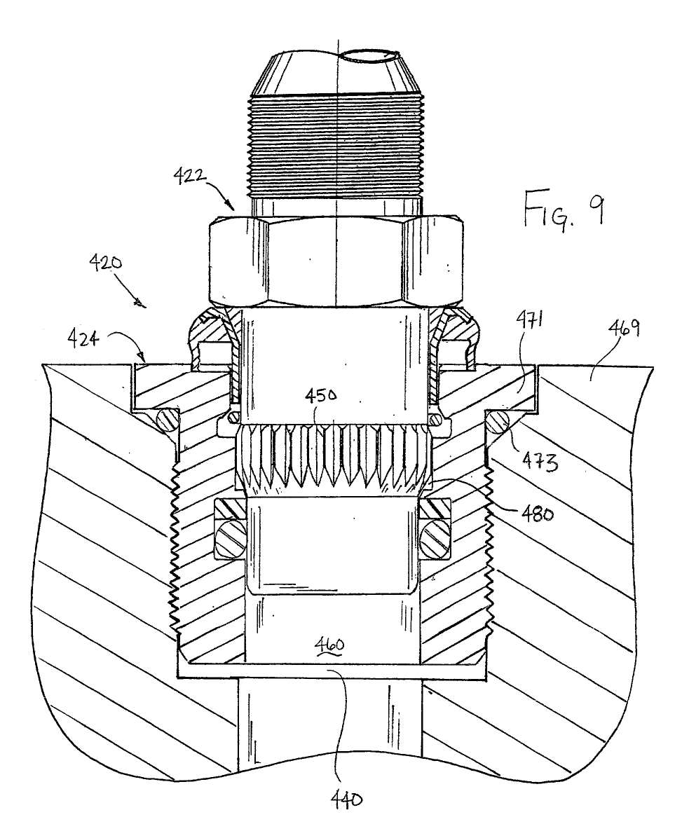

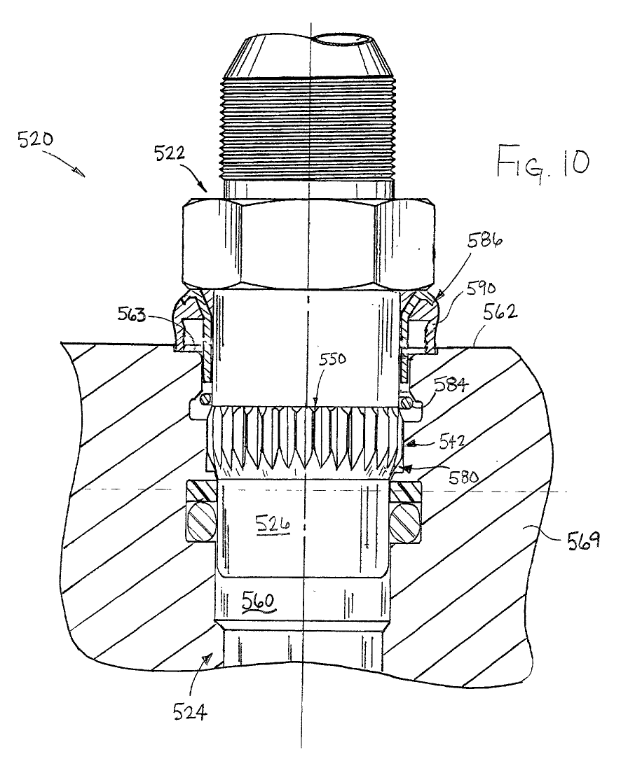

Referring to FIG. 9, another embodiment of the present invention is shown in detail. In this embodiment, a coupling assembly 420 is provided having a first or “male” coupling member 422 that is substantially similar to first member 22 as described in the preferred embodiment and a second or “female” coupling member 424. The second coupling member 424 is substantially similar to second coupling member 24 described in the preferred embodiment with at least one exception, namely, second member 424 is substantially shorter in axial length. Second member 424 also includes a flange 471 that extends radially outwardly from second member 424. A sealing member 473, such as an o-ring, is disposed between flange 471 and an apparatus 469, such as a manifold, to seal against the escape of fluid when second member 424 is connected to apparatus 469.

In order to secure second member 424 into a threaded port 440 of apparatus 469, a separate tool (not illustrated) may be used to engage locking features 480 in receiving portion 460 and rotate second member 424 into the threaded port of the apparatus. The tool may include one or more engagement features substantially similar to the engagement features 450 on first member 422.

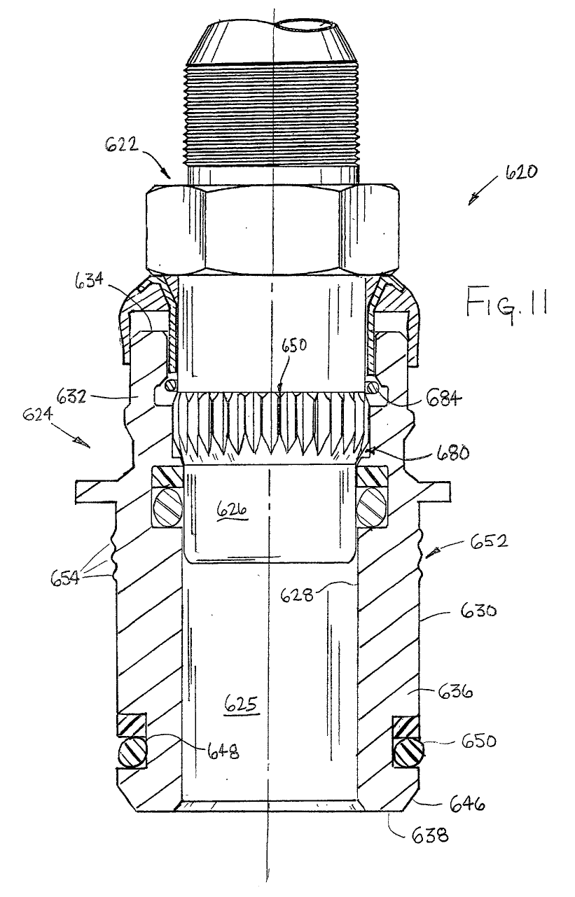

Referring to FIG. 10, yet another embodiment of the present invention is shown in detail. In this embodiment, a coupling assembly 520 is provided having a first or “male” coupling member 522 that is substantially similar to first member 22 described in the preferred embodiment and a second or “female” coupling member 524. As illustrated in FIG. 10, second member 524 is integrally formed into an apparatus 569, such as a pump or manifold. Second member 524 may be formed in apparatus 569, for example, by machining, molding or casting the profile of second member 524 directly into the body of the apparatus 569.

A receiving end 562 of second member 524 preferably includes a recess 563 that is sealingly engaged by a flexible sealing portion 590 of a release member 586 while first member 522 is connected to second member 524. Flexible sealing portion 590 seals in both an axial and radial direction to substantially inhibit the entry of dirt and other debris into a receiving portion 560 of second member 524. Recess 563 provides a finished surface having a quality suitable for sealing with flexible sealing portion 590. However, recess 563 is not necessarily needed if the surface quality of receiving end 562 is suitable for sealing with flexible sealing portion 590 and, in addition, the benefit of a radial seal is not required.

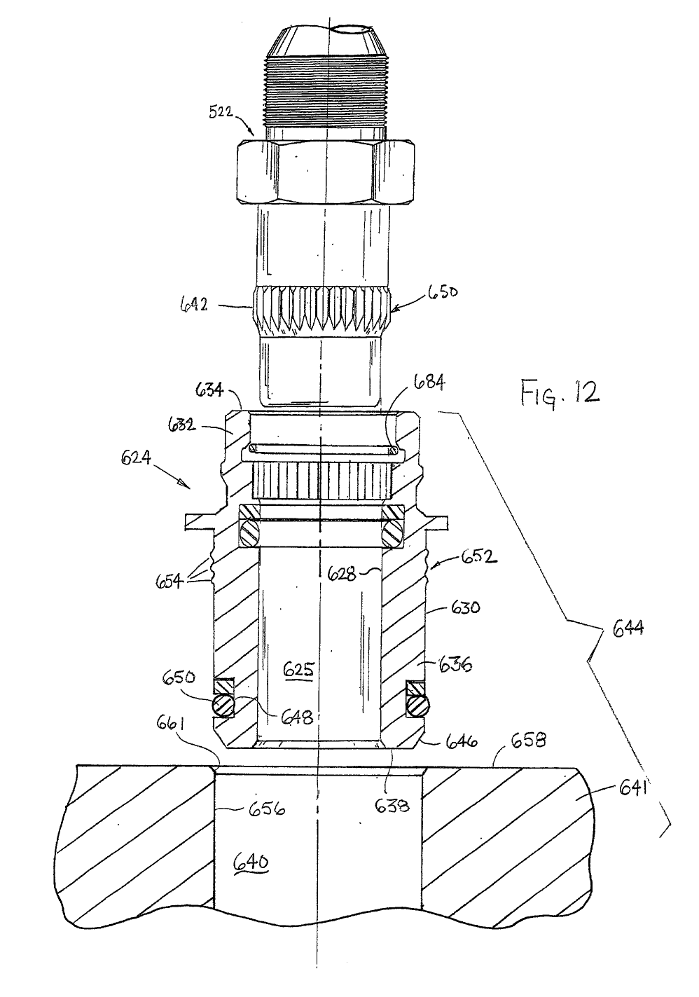

Referring to FIGS. 11 and 12, still another embodiment of the present invention is shown in detail. In this embodiment, a coupling assembly 620 is provided having a first or “male” coupling member 622 that is substantially similar to first member 22 as described in the preferred embodiment and a second coupling member 624. Second member 624 includes a generally cylindrical-shaped body having a central longitudinal channel 625 and an inner and outer surface 628 and 630, respectively. Second member 624 includes an external segment 632 having an external end 634 and an internal segment 636 having an internal end 638. Central longitudinal channel 625 extends from external end 634 to internal end 638.

Referring to FIG. 12, internal segment 636 is configured for receipt within a port 640 of an apparatus 641, such as, for example, a pump or manifold. The configuration of port 640 may be of a conventional design, such as, for example, that disclosed in proposed SAE standard J2494-4. When securely retained within port 640, second member 624 and port 640 together comprise a female coupling member 644 suitable for receiving first member 622, as will be described in detail below.

Outer surface 630 of internal segment 636 includes a lead-in chamfer 646 adjacent internal end 638 that forms a chamfer angle relative to outer surface 630. Chamfer 646 is designed to aid in positioning internal end 638 within port 640 for insertion into apparatus 641. An annular groove 648 is preferably positioned proximate internal end 638 and is sized to receive at least one flexible member 650, such as an O-ring. Flexible member 650 functions to create a seal to inhibit fluid leakage between port 640 and second member 624 and also provides a means of dampening vibrational energy transmitted between port 640 and second member 624.

Outer surface 630 further includes a fit portion 652 that preferably includes at least one outward radially projecting fitting protrusion 654. While the outer radial portion of fitting protrusion 654 preferably includes a generally semicircular outer radius, it is recognized that the outer radial portion of fitting protrusion 654 may exhibit other profiles, such as a generally flat profile for example. Fitting protrusions 654 create a series of “peaks” and “valleys” for facilitating the retention of second member 624 within port 640. The material of apparatus 641 preferably exhibits a lesser material strength and/or a more porous composition than the material of second member 624 enabling fitting protrusions 654 to engage or “lock” into apparatus 641 by means of a mini-broaching-type technique in which the material of apparatus 641 is pulled or forced down into the “valleys” created between fitting protrusions 654.

Fitting protrusions 654 are generally sized and positioned to minimize the work, i.e. force times distance, required to insert second member 624 into port 640. It is recognized that increasing the number of fitting protrusions 654 generally increases the work required to insert second member 624 into port 640 and, alternatively, decreasing the number of fitting protrusions 654 generally decreases the work required to insert second member 624, if they are the same diameter. Fitting protrusions 654 may be of substantially equal diameter or, alternatively, may decrease in diameter in a direction away from external segment 632 to decrease the work required to insert second member 624 into port 640.

Second member 624 preferably includes a means of engaging and securing first member 622 that is substantially similar to receiving portion 60 of second member 24 as described in the preferred embodiment. However, the engagement features 650 and locking features 680 of the first and second members 622 and 624, respectively, are not limited to that illustrated in FIGS. 11 and 12, and may comprise other features, such as, for example, those illustrated in FIGS. 3 and 4.

Referring to FIG. 12, port 640 of apparatus 641 preferably includes a substantially smooth, non-threaded, internal surface 656 that extends from an external surface 658. Internal surface 656 preferably includes an external chamfer segment 660 adjacent external surface 658 that forms a chamfer angle relative to port 640. Chamfer segment 661 cooperates with chamfer 646 in second member 624 to guide the insertion of second member 624 into port 640. The diameter of port 640 is slightly smaller than the diameter of fitting protrusions 654 requiring second member 624 to be inserted into port 640 under force.

In order to secure second member 624 into port 640, internal segment 636 is aligned and inserted into port 640 until fit portion 652 engages internal surface 656. Second member 624 preferably comprises a material having a relatively high material strength, such as steel, and apparatus 641 preferably comprises a material having a lesser material strength and/or a more porous nature, such as brass. Second member 624 is then pressed into port 640 under a pressure sufficient to cause the relatively “softer” material of apparatus 641 proximate internal surface 656 to be forced into the “valleys” between fitting protrusions 654.

Alternatively, it will be appreciated by those skilled in the art that internal surface 656 of apparatus 641 may include fit portion 652 and that second member 624 may comprise a material having a lesser material strength and/or a more porous nature than the material of apparatus 641. In this configuration, i.e. the inverse of the configuration described above, second member 624 is pressed into port 640 under a pressure sufficient to cause the relatively “softer” material of second member 624 to be forced into the “valleys” between the fitting protrusions 654.

It will also be appreciated by those skilled in the art that second member 624 may include fit portion 652 and comprise a material having a lesser material strength and/or a more porous nature than the material of apparatus 641. In this configuration, second member 624 is pressed into port 640 under a pressure sufficient to cause the relatively “softer” material of second member 624, more particularly fit portion 652, to deform and create a compression fit type of engagement against internal surface 656.

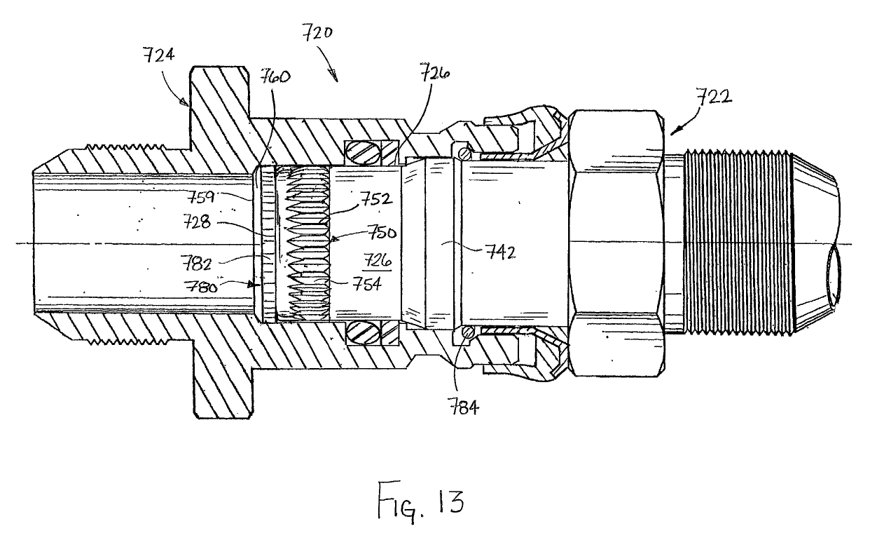

Referring to FIG. 13, still yet another embodiment of the present invention is shown in detail. In this embodiment, a coupling assembly 720 is provided having a first or “male” coupling member 722 and a second “female” coupling member 724. The first member 722 is substantially similar to the first member 22 as described in the preferred embodiment with at least one exception, namely, first member 722 includes one or more engagement features 750 located proximate an engagement end 728 of first member 722. Second member 724 is substantially similar to the second member 24 as described in the preferred embodiment with at least one exception, namely, second member 724 includes one or more locking features 780 proximate and interior end 759 of a receiving portion 760.

As illustrated in FIG. 13, by way of example only and without limitation, engagement features 750 comprise a plurality of teeth 752 that are defined by a plurality of grooves 754 that extend inwardly from a first exterior surface 726 of first member 722. Referring to second member 724, receiving portion 760 has formed therein a plurality of grooves 782 that are configured to mate with teeth 752 of first member 722. As first member 722 is inserted into second member 724, teeth 752 intermesh with grooves 782 to prevent rotation of first member 722 relative to second member 724.

Among other advantages, the coupling assembly of the present invention prevents rotation of the first member 22 relative to the second member 24 while connected thereto. Another advantage is that the locking feature 80 of the second member 24 may be used with a tool to connect the second member 24 to an apparatus, such as a pump or manifold. Still another advantage is that the invention provides a user improved tactile feel during assembly that the first member 22 has been satisfactorily connected to the second member 24. The present invention also lends itself to providing, when appropriate and desired, a quick-connect and/or releasable coupling assembly 20.

Although certain preferred embodiments of the present invention have been described, the invention is not limited to the illustrations described and shown herein, which are deemed to be merely illustrative of the best modes of carrying out the invention. A person of ordinary skill in the art will realize that certain modifications and variations will come within the teachings of this invention and that such variations and modifications are within its spirit and the scope as defined by the claims.

What is claimed is:

1. A coupling assembly, comprising:
a first member having an exterior surface, the exterior surface including at least one engagement feature; and
a second member having a portion for receiving a portion of the first member, the receiving portion having at least one interior surface that includes at least one locking feature configured to mate with the engagement feature of the first member to substantially prevent rotation of the first member relative to the second member during connection thereto.

2. A coupling assembly as recited in claim 1, wherein the engagement feature is defined by at least one protrusion in the exterior surface of the first member, the protrusion extending outward from a base reference point.

3. A coupling assembly as recited in claim 2, wherein the locking feature is defined by at least one interruption in the interior surface of the receiving portion, said interruption extending outward with respect to the base point.

4. A coupling assembly as recited in claim 3, wherein the engagement and locking features are received in the corresponding protrusion and interruption of the opposing member to create a radial interference.

5. A coupling assembly as recited in claim 4, wherein there are a plurality of protrusions and interruptions, the protrusions and the interruptions located on the respective members such that there is at least one orientation, wherein the members may fully engage by way of a mating of the protrusions and the interruptions.

6. A coupling assembly as recited in claim 1, wherein the engagement feature comprises a plurality of teeth.

7. A coupling assembly as recited in claim 6, wherein the locking feature comprises a plurality of grooves, the teeth of the first member configured to intermesh with the grooves of the second member.

8. A coupling assembly as recited in claim 1, wherein the engagement feature comprises a plurality of tabs.

9. A coupling assembly as recited in claim 8, wherein the locking feature comprises a plurality of slots that are configured to receive the tabs of the first member.

10. A coupling assembly as recited in claim 1, wherein several engagement features are substantially equidistantly spaced around the exterior surface of the first member.

11. A coupling assembly as recited in claim 1, wherein several engagement features are non-equidistantly spaced around the exterior surface of the first member.

12. A coupling assembly as recited in claim 1, wherein the engagement feature includes a tapered ramp and a shoulder.

13. A coupling assembly as recited in claim 12, wherein an apex is disposed between the tapered ramp and the shoulder.

14. A coupling assembly as recited in claim 13, wherein the apex is a substantially flat surface.

15. A coupling assembly as recited in claim 13, wherein a locking member is disposed between the first and second members for substantially locking movement of the first member relative to the second member in an axial direction.

16. A coupling assembly as recited in claim 15, wherein when the first member is sufficiently inserted into the second member, the exterior surface passes through the locking member where, upon further insertion, the locking member is expanded over the apex until it clears the apex whereby, the locking member contracts to a position between the first member and the second member to interconnect the members.

17. A coupling assembly as recited in claim 15, wherein the receiving portion of the second member includes an inwardly facing groove for receiving therein the locking member.

18. A coupling assembly as recited in claim 1 further including a release member moveably mounted on the first member for releasing the first member from the second member.

19. A coupling assembly as recited in claim 18, wherein the release member includes a flexible sealing portion, the flexible sealing portion configured to sealingly engage the second member upon connection of the first and second members.

20. A coupling assembly as recited in claim 1, wherein the first member includes an elbow.

21. A coupling assembly, comprising:
a first member having an exterior surface and a retaining formation, the retaining formation including at least one engagement feature;
a second member having a portion for receiving a portion of the first member, the second member including at least one locking feature configured to mate with the engagement feature of the first member to substantially prevent rotation of the first member relative to the second member during connection thereto, the receiving portion including an inwardly facing groove configured to receive a locking member; and whereby, when the first member is sufficiently inserted into the second member, the exterior surface passes through the locking member where, upon further insertion, the locking member is expanded over the retaining formation until it clears the retaining formation whereby, the locking member contracts to a position between the first member and the second member to interconnect the members.

22. A coupling assembly as recited in claim 21, wherein the retaining formation is a portion of the engagement features.

23. A coupling assembly suitable for transmitting a flow of fluid into and out of an apparatus, comprising:
a first member having an exterior surface that includes at least one engagement feature; and
a second member having a portion for receiving a portion of the first member, the receiving portion being integrally formed in the apparatus, the second member including at least one locking feature configured to mate with the engagement feature of the first member to substantially prevent rotation of the first member relative to the second member during connection thereto.

24. A coupling assembly as recited in claim 23, wherein the first member includes a retaining formation and the receiving portion of the second member includes a locking member, whereby, when the first member is sufficiently inserted into the second member, the exterior surface passes through the locking member where, upon further insertion, the locking member is expanded over the retaining formation until it clears the retaining formation whereby, the locking member contracts to a position between the first member and the second member to interconnect the members.

25. A coupling assembly suitable for transmitting a flow of fluid into and out of an apparatus, comprising:
a first member having an exterior surface that includes at least one engagement feature; and
a second member that includes an external segment having an external end, an internal segment having an internal end, the internal segment including a fit portion for engaging the apparatus upon receipt of second member within a port of the apparatus, the second member further including a portion for receiving a portion of the first member, the receiving portion including at least one locking feature configured to mate with the engagement feature of the first member to substantially prevent rotation of the first member relative to the second member during connection thereto.

26. A coupling assembly as recited in claim 25, wherein the first member includes a retaining formation and the receiving portion of the second member includes a locking member,
whereby, when the first member is sufficiently inserted into the second member, the exterior surface passes through the locking member where, upon further insertion, the locking member is expanded over the retaining formation until it clears the retaining formation whereby, the locking member contracts to a position between the first member and the second member to interconnect the members.

27. A coupling assembly, comprising:
a first member having an engagement end and an exterior surface that includes at least one engagement features, the engagement feature positioned proximate the engagement end; and
a second member having a portion for receiving a portion of the first member, the receiving portion including at least one locking feature configured to mate with the engagement feature of the first member to substantially prevent rotation of the first member relative to the second member during connection thereto.

28. A coupling assembly as recited in claim 27, wherein the first member includes a retaining formation and the receiving portion of the second member includes a locking member,
whereby, when the first member is sufficiently inserted into the second member, the exterior surface passes through the locking member where, upon further insertion, the locking member is expanded over the retaining formation until it clears the retaining formation whereby, the locking member contracts to a position between the first member and the second member to interconnect the members.
